(19) United States
(12) Patent Application Publication
(10) Pub. No.: US 2011/0148571 A1
(43) Pub. Date: Jun. 23, 2011

(54) DEVICE FOR POWERING ON COMPUTER

(75) Inventors: TING GE, Shenzhen City (CN); SONG-LIN TONG, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/727,251

(22) Filed: Mar. 19, 2010

(30) Foreign Application Priority Data
Dec. 23, 2009 (CN) 200910312099.8

(51) Int. Cl. G06F 7/04

(52) U.S. Cl. 340/5.51

(57) ABSTRACT

A coded entry controlled device can power on a computer. A control circuit receives a power on coded entry via a keyboard and compares the input power on coded entry with an entry pre-stored in a storage circuit. The microcontroller actuates a switch circuit to power on the computer in response to a correct entry.

### BACKGROUND

1. Technical Field

The present disclosure relates to a device for powering on a computer.

2. Description of Related Art

A logon password of a computer is generally set to an operating system in a basic input/output system (BIOS) by a user. Whenever a computer is powered up, there will be a prompt for a password to log in. However, using this method, a user must access the BIOS to set the password, thereby making operations inconvenient.

### BRIEF DESCRIPTION OF THE DRAWINGS

FIG. 1 is a schematic, isometric view of an exemplary embodiment of a coded entry controlled device for powering on a computer.

FIG. 2 is a circuit diagram of the device for powering on a computer of FIG. 1.

### DETAILED DESCRIPTION

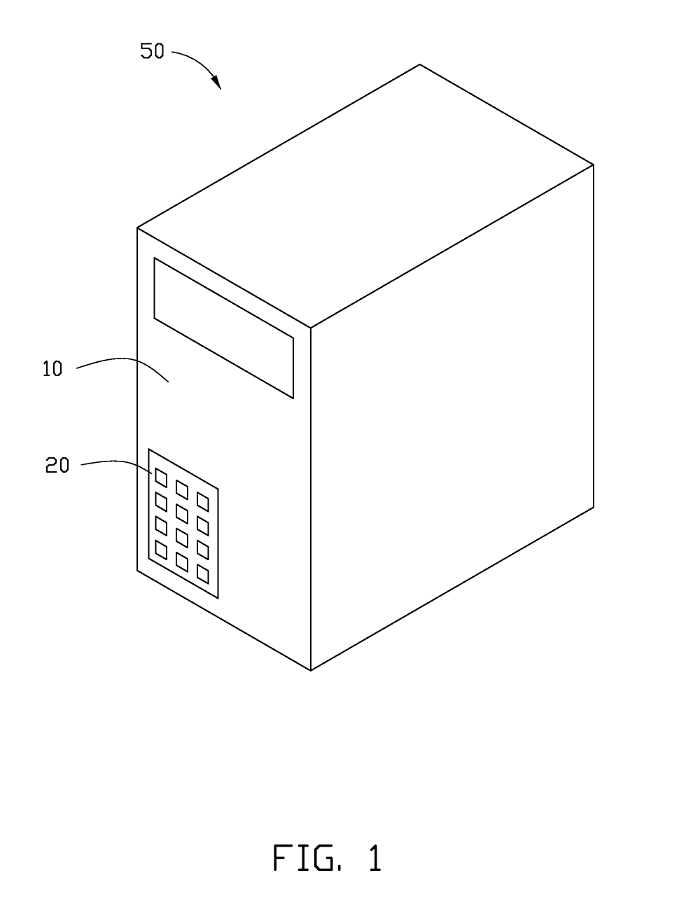

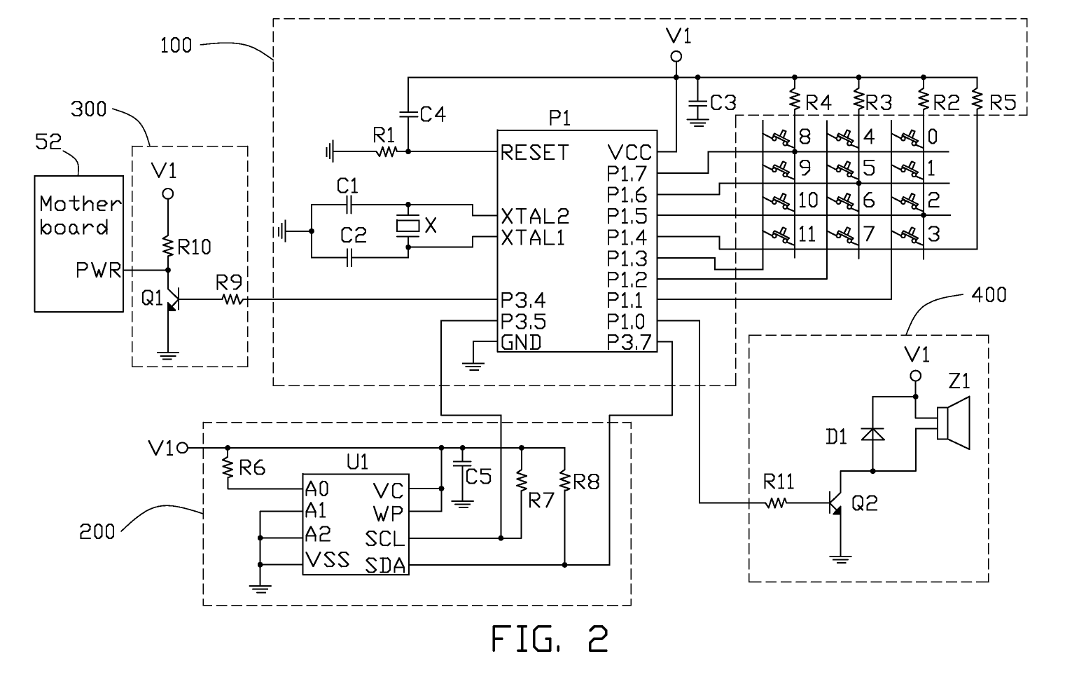

Referring to FIGS. 1 and 2, an exemplary embodiment of a coded entry controlled device for powering on a computer 50 includes a keyboard 20 arranged on an enclosure 10 of the computer 50, and a control circuit 100, a storage circuit 200, a switch circuit 300, and an instruction circuit 400 arranged in the enclosure 10. The keyboard 20 includes twelve keys 0-11 (e.g., ten number keys 0-9, a password setting key 10, and an acknowledgement key 11).

The keyboard 20, the storage circuit 200, the switch circuit 300, and the instruction circuit 400 are all connected to the control circuit 100. The control circuit 100 receives a power on coded entry via the keyboard 20 and compares the entry with a pre-stored entry in the storage circuit 200. The control circuit 100 actuates the switch circuit 300, to power on the computer 50 in response to a correct entry. The instruction circuit 400 guides a user to proceed with a next operation according to the input.

The control circuit 100 includes a crystal oscillator X, a microcontroller P1, five resistors R1-R5, and four capacitors C1-C4. The microcontroller P1 includes two crystal terminals XTAL1 and XTAL2, a power supply terminal VCC, a reset terminal RESET, a clock terminal P3.5, a data terminal P3.7, a ground terminal GND, three row input terminals P1.1-P1.3, four column output terminals P1.4-P1.7, and two control terminals P1.0 and P3.4. The crystal oscillator X is connected between the crystal terminals XTAL1 and XTAL2. The crystal terminals XTAL1 and XTAL2 are also grounded via the capacitors C1 and C2, respectively. The power supply terminal VCC is connected to a power supply V1, grounded via the capacitor C3, and also connected to the reset terminal RESET of the microcontroller P1 via the capacitor C4. The reset terminal RESET of the microcontroller P1 is also grounded via the resistor R1. The row input terminal P1.1 of the microcontroller P1 is connected to first terminals of the four keys 0-3, and second terminals of the keys 0-3 are vacant (not connected to anything). When the keys 0-3 are pressed, the second terminals of the keys 0-3 are connected to the column output terminals P1.7, P1.6, P1.5, and P1.4, respectively. The row input terminal P1.2 of the microcontroller P1 is connected to first terminals of the four keys 4-7, and second terminals of the keys 4-7 are vacant. When the keys 4-7 are pressed, the second terminals of the keys 4-7 are connected to the second terminals of the column output terminals P1.7, P1.6, P1.5, and P1.4, respectively. The row input terminal P1.3 of the microcontroller P1 is connected to first terminals of the four keys 8-11, and second terminals of the keys 8-11 are vacant. When the keys 8-11 are pressed, the second terminals of the keys 8-11 are connected to the column output terminals P1.7, P1.6, P1.5, and P1.4, respectively. The column output terminals P1.4-P1.7 of the microcontroller P1 are connected to the power supply V1 via the resistors R5, R2, R3, and R4, respectively. The clock terminal P3.5 and the data terminal P3.7 are connected to the storage circuit 200. The control terminal P1.0 is connected to the instruction circuit 400. The control terminal P3.4 is connected to the switch circuit 300. The ground terminal GND is grounded. In this embodiment, the power supply V1 may be a 5 volt (V) direct current (DC) power supply, and a type of the microcontroller P1 is 89C2051. In other embodiments, the power supply V1 can be another type of power supply, and the microcontroller P1 can be other types of controllers.

The storage circuit 200 includes a memory chip U1, three resistors R6-R8, and a capacitor C5. The memory chip U1 includes three power terminals VC, WP, and A0, a clock terminal SCL, a data terminal SDA, and three ground terminals A1, A2, and VSS. The power terminals VC and WP are both connected to the power supply V1, and also grounded via the capacitor C5. The power terminal A0 is connected to the power supply V1 via the resistor R6. The clock terminal SCL is connected to the power supply V1 via the resistor R7, and also connected to the clock terminal P3.5 of the microcontroller P1. The data terminal SDA is connected to the power supply V1 via the resistor R8, and also connected to the data terminal P3.7 of the microcontroller P1. The ground terminals A1, A2, and VSS are grounded. In this embodiment, the memory chip U1 is an electrically erasable programmable read only memory (EEPROM) chip; type CAT24C64. In other embodiments, the memory chip U1 can be other types of memory chips.

The switch circuit 300 includes a transistor Q1, and two resistors R9 and R10. A base of the transistor Q1 is connected to the control terminal P3.4 of the microcontroller P1 via the resistor R9. An emitter of the transistor Q1 is grounded. A collector of the transistor Q1 is connected to the power supply V1 via the resistor R10, and also connected to a control terminal PWR of a motherboard 52 of the computer 50. In this embodiment, the transistor Q1 functioning as an electronic switch is an npn transistor. In other embodiments, the transistor Q1 can be other types of electronic switches, such as an N-channel metal oxide semiconductor field effect transistor (NMOSFET).

The instruction circuit 400 includes a transistor Q2, a diode D1, a buzzer Z1, and a resistor R11. A base of the transistor Q2 is connected to the control terminal P1.0 of the microcontroller P1 via the resistor R11. An emitter of the transistor Q2 is grounded. A collector of the transistor Q2 is connected to an anode of the diode D1. A cathode of the diode D1 is connected to the power supply V1. The buzzer Z1 is connected between the anode and the cathode of the diode D1. In this embodiment, the transistor Q2 functioning as an electronic switch is an npn transistor. In other embodiments, the transistor Q2 can be other types of electronic switches, such as an NMOSFET. The instruction circuit 400 can be omitted as needed.

The following depicts how a power on entry code is set using the device and is thereafter used to power on the computer 50. In this embodiment, the key 10 is a password setting key, the key 11 is an acknowledgement key, and the keys 0-9 is number keys 0-9 preset in the microcontroller P1. The row input terminals P1.1-P1.3 of the microcontroller P1 take turns to output low level signals (e.g., 0V). The microcontroller P1 simultaneously scans the column output terminals P1.4-P1.7. If one of the column output terminals P1.4-P1.7 outputs a low level signal, the key which is connected to the corresponding one of the column output terminals P1.4-P1.7 is determined to be pressed. For example, when the key 0 is pressed, the fist and second terminals of the key 0 are connected. As the row input terminal P1.1 which is connected to the first terminal of the key 0 is at a low level, the column output terminal P1.7 which is connected to the second terminal of the key 0 is at a low level, and the key 0 is determined to be pressed.

When the key 10 is pressed to set a power on entry code, at least one of the keys 0-9 is pressed, and then the key 11 is pressed to finish setting the entry code. The power on entry code is stored in the memory chip U1 via the clock terminal P3.5 and the data terminal P3.7 of the microcontroller P1, and the clock terminal SCL and the data terminal SDA of the memory chip U1. In detail, when the key 10 is pressed to set the entry code, the control terminal P1.0 of the microcontroller P1 may output high and low level pulse signals (e.g., 010101). When the control terminal P1.0 of the microcontroller P1 outputs a high level signal, the transistor Q2 is turned on, and the buzzer Z1 sounds once. When the control terminal P1.0 outputs 010101 pulse signals, the buzzer Z1 sounds thrice to prompt user to input current power on coded entry. When the user inputs the current power on coded entry and presses the key 11, the microcontroller P1 compares the input current power on coded entry with the entry pre-stored in the memory chip U1. If the input current power on coded entry is equal to the pre-stored entry, the input current power on coded entry is determined to be correct, the control terminal P1.0 of the microcontroller P1 outputs high and low level pulse signals (e.g., 010,101,010,101), and the buzzer Z1 sounds six times to prompt user to input a new power on coded entry. The user inputs a first new power on coded entry and presses the key 11, the control terminal P1.0 of the microcontroller P1 outputs high and low level pulse signals (e.g., 010,101,010,101), and the buzzer Z1 sounds six times to prompt user to input the new power on coded entry again. The user inputs a second new power on coded entry and presses the key 11, the microcontroller P1 compares the first and second new power on coded entries. If the first new power on coded entry is equal to the second new power on coded entry, the new power on coded entry is determined to be set successfully. The new power on coded entry will be stored in the memory chip U1 via the clock terminal P3.5 and the data terminal P3.7 of the microcontroller P1, and the clock terminal SCL and the data terminal SDA of the memory chip U1. The control terminal P1.0 of the microcontroller P1 outputs a high level signal (e.g., 1V), and the buzzer Z1 sounds once to prompt the user that the new power on coded entry has been set successfully.

When the computer 50 needs to be powered on, the user inputs a power on coded entry via pressing the corresponding keys 0-9 of the keyboard 20 and pressing the key 11, the microcontroller P1 compares the input power on coded entry with the entry pre-stored in the memory chip U1. If the input power on coded entry is equal to the pre-stored entry, the input power on coded entry is determined to be correct, the control terminal P1.0 of the microcontroller P1 outputs high and low level pulse signals (e.g., 0101010101010101), the buzzer Z1 sounds eight times to prompt the user that the input power on coded entry is correct. The control terminal P3.4 of the microcontroller P1 outputs a high level signal, and the transistor Q1 of the switch circuit 300 is turned on. The control terminal PWR of the motherboard 52 is at low level (e.g., 0V) to power on the computer. If the input power on coded entry is not correct, the control terminal P1.0 of the microcontroller P1 outputs high and low level pulse signals (e.g., 01010101), the buzzer Z1 sounds four times to prompt the user to input the correct power on coded entry again. If the input power on coded entry is incorrectly input for three times, the microcontroller P1 locks the keyboard 20 for a period of time (e.g., 10 minutes) via not scanning the column output terminals P1.4-P1.7.

In other embodiments, the control terminal P1.0 of the microcontroller P1 can also be set to output other pulse signals as needed to prompt the user for next operation.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A coded entry controlled device for powering on a computer, the device comprising:
a keyboard comprising a plurality of keys to set and input a power on coded entry;
a microcontroller connected to the keyboard, and comprising a plurality of row input terminals and column output terminals, and a control terminal; wherein each of the row input terminals is connected to first terminals of a corresponding one of the keys, and second terminals of the keys are vacant, the row input terminals take turns to output low level signals, the microcontroller simultaneously scans the column output terminals, and compares the input power on coded entry with a pre-stored entry, the control terminal outputs a high level signal in response to a correct entry;
a memory chip connected to the microcontroller and storing the pre-stored entry; and
a switch circuit connected to the microcontroller and a control terminal of a motherboard of the computer, to be turned on by the microcontroller to power on the computer.

2. The device of claim 1, wherein the microcontroller further comprises two crystal terminals, a power supply terminal, a reset terminal, a clock terminal, and a data terminal; a crystal oscillator is connected between the two crystal terminals, the two crystal terminals are also grounded via first and second capacitors, respectively, the power supply terminal is connected to a power supply, grounded via a third capacitor, and also connected to the reset terminal of the microcontroller via a fourth capacitor, the reset terminal of the microcontroller is also grounded via a first resistor, the clock terminal and the data terminal are connected to the memory chip.

3. The device of claim 2, wherein the power supply is a 5 volt direct current power supply.

4. The device of claim 3, wherein the memory chip is an electrically erasable programmable read only memory chip.

5. The device of claim 2, wherein the memory chip comprises at least one power terminal, a clock terminal, a data terminal, and at least one ground terminal, the at least one power terminal is connected to the power supply, and also grounded via a fifth capacitor, the clock terminal is connected to the power supply via a second resistor, and also connected to the clock terminal of the microcontroller, the data terminal is connected to the power supply via a third resistor, and also connected to the data terminal of the microcontroller, and the ground terminal is grounded.

6. The device of claim 2, wherein the switch circuit comprises an electronic switch, a first terminal of the electronic switch is connected to the microcontroller via a second resistor, a second terminal of the electronic switch is grounded, a third terminal of the electronic switch is connected to the power supply via a third resistor, and also connected to the control terminal of the motherboard of the computer, when the microcontroller receives a correct power on coded entry, the first terminal of the electronic switch is at high level, the electronic switch is turned on to power on the computer.

7. The device of claim 6, wherein the electronic switch is an npn transistor, and the first to third terminals of the electronic switch are a base, an emitter, and a collector of the transistor, respectively.

8. The device of claim 2, further comprising an electronic switch, a diode, and a buzzer, a first terminal of the electronic switch is connected to the microcontroller via a second resistor, a second terminal of the electronic switch is grounded, a third terminal of the electronic switch is connected to an anode of the diode, a cathode of the diode is connected to the power supply, and the buzzer is connected between the anode and the cathode of the diode, the microcontroller outputs different control signals to make the buzzer sound different times.

9. The device of claim 8, wherein the electronic switch is an npn transistor, and the first to third terminals of the electronic switch are a base, an emitter, and a collector of the transistor, respectively.
